(19) United States
(12) Patent Application Publication
(10) Pub. No.: US 2009/0065616 A1
(43) Pub. Date: Mar. 12, 2009

(54) PAPER SHREDDING TRUCK

(76) Inventor: Nicholas G. Walsh, Croton-on-Hudson, NY (US)

Correspondence Address: COLLEN IP, THE HOLYOKE MANHATTAN BUILDING, 80 SOUTH HIGHLAND AVENUE, OSSINING, NY, 10562, US

(21) Appl. No.: 12/207,907

(22) Filed: Sep. 10, 2008

Related U.S. Application Data
(60) Provisional application No. 60/971,003, filed on Sep. 10, 2007.

(51) Int. Cl. B02C 19/00; B02C 23/00; B02C 25/00

(52) U.S. Cl. 241/33; 241/101.74; 241/100; 241/25; 241/28

(57) ABSTRACT

The present invention is a truck for paper shredding including means to lift containers of paper, dump them into a shredder. The shreds fall into a hopper from where a ram then compresses and moves the shreds to a storage unit, This compression allows the unit to process significantly more paper shreds before being required to drive to a dumping location.

### CROSS REFERENCES TO RELATED APPLICATIONS

This non-provisional application claims priority from pending provisional Application No. 60/971,003 filed in the United States Patent and Trademark Office on Sep. 10, 2007.

### BACKGROUND

Identity theft is becoming a paramount issue in the business and personal environments. Methods to combat loss of vital information to those who will use it to unlawful means are growing. Because of this, a new industry has been gaining strength in the past twenty (20) years, that is, the shredding or destruction of vital or confidential information.

One of the present methods to safeguard privacy of information has been the design, sale and use of mobile shredding trucks, which basically have paper shredding machinery built into or onto a standard body box truck. These trucks perform what is known in the industry as ON SITE shredding which is performed at the customer's facility or other location(s) of choice.

These mobile shredding trucks can be purchased commercially and are all basically constructed the same with some minor variations from builder to builder. The shredded paper is moved to the back of the truck by air or be an auger. But in either case very little compression takes place.

### SUMMARY

This invention provides novel more efficient trucks and method for mobile shredding operations than currently exist and provides for compression of the shredded paper to allow more shredded paper to be stored before requiring the truck to be emptied.

### BRIEF DESCRIPTION OF DRAWINGS

FIG. 1 depicts side view of a typical arrangement of the lifting, shredding, ram and storage units of this invention.

### GLOSSARY OF TERMS

Shredder/hammermill: A device for reducing the size of an item by either forcing the material through a screen of various dimensions by means of rotating swinging arms or through rotating shafts of cutters that cut material into strips or sizes depending on the screen size.

Side-loaded waste collection truck: A trash collection truck which is loaded from the side(s) instead of one which is generally loaded from the rear. The side-loader has a collection hopper which, when full, is emptied by actuating a hydraulic ram which pushes the material out of the hopper into a collection area in the rear of the truck.

Standard lifting arm: A typically hydraulic device which grabs a bin at ground level, lifts, tilts and empties it into the collection hopper.

### DESCRIPTION

As described above, currently manufactured mobile shredding trucks have one thing in common. That is, they are manufactured around a truck chassis with a standard box body on the chassis. This invention is to marry a standard paper shredder to a side-loaded refuse collection truck which has build in features that can greatly increase the efficiency of on-site document destruction vehicles.

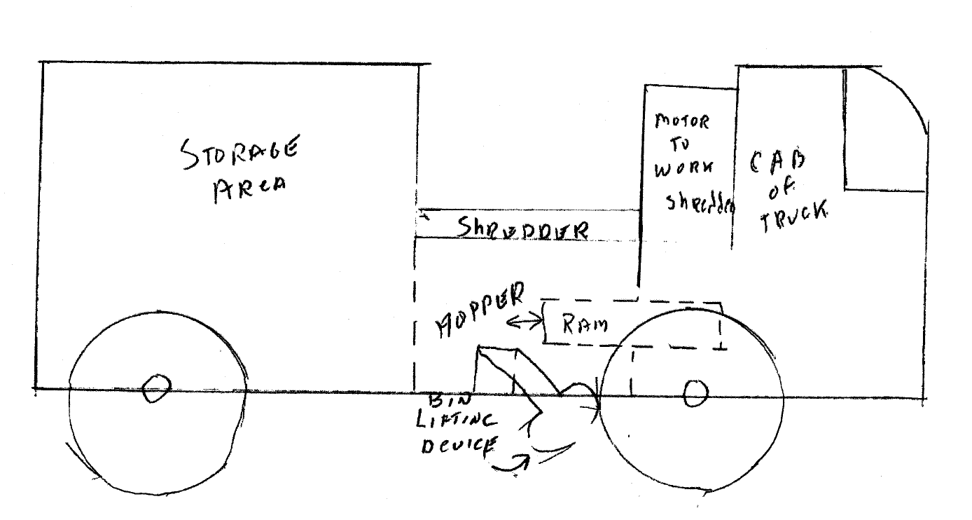

As depicted on FIG. 1 this invention mounts a cab on the front of a truck body. Behind the cab is a shredding unit with a drive mechanism of this shredding unit typically mounted between the cab and the shredding unit. This novel truck is equipped with a standard lifting arm to lift commonly used containers, (typically 64 and 96 gallon plastic containers), the material to be destroyed is lifted, tilted, and emptied into the paper shredder. The lifting arm can be mounted on either the driver side or the curb side of the truck as warranted by particular applications. The lifting arm is typically hydraulically driven but can be driven by other means as warranted.

The material is then shredded, and the shreds fall into the standby hopper mounted below the shredding unit. The shredding unit can be any of the available shredders such as strip shredder, rotary shredder or hammer mill shredder units. When the hopper is full, a hydraulic ram compresses and pushes the shreds into the rear of the truck's on which is mounted a storage unit (typically 20 to 28 cubic yard). The weight of a cubic yard of paper is approximately 500 pounds, thus a 28 cubic yard container will hold about 7 tons of paper. Upon reaching the capacity of the truck, the shredded paper inside the storage container is emptied out the rear door where it is prepared for recycling. The emptying operation can be accomplished in numerous ways such as utilizing the same ram using for loading the unit; tilting the storage unit or a separate ram to empty the unit.

The shredder can be powered by one of three methods:
1. hydraulically;
2. direct drive engine which is mounted on the truck; or
3. electric generator power unit.

A control system is provided for each of the 3 operations (lifting, shredding, compressing/storing). Each of these systems can be controlled manually or integrated with each other to be automated to be run consecutively as required. Sensors are provided to ensure the operation safe efficient operation of the 3 operations including detection of jamming, level, overloads, fire, etc.

The description above and accompanying figure are presented as examples of the present invention. The scope of the present invention is not limited by the exemplary embodiments included. It is recognized that obvious modifications will occur to a person skilled in the art. Other applications and variations are possible to meet a particular application. For example the lifting mechanism can me mounted on the rear of the truck and lift the containers over the top of the storage unit. The locations of each of the shredding and shredding drive mechanism and storage units along with the size and shape of the truck unit can be varied as warranted. And the units can alternatively be mounted on a trailer and pulled by trucks or other driven vehicles

I claim the following:

1. A paper shredding truck unit comprising:
a truck body including 4 sides referred to as front, rear, driver side and curb side;
a driver cab mounted on the front of said truck body;
a shredding unit mounted adjacent to the driver cab and toward the rear of the truck body;
a lifting arm mounted on the truck body wherein it is designed to lift containers of paper and dump its contents into the shredding unit;
a drive mechanism for the shredder unit mounted on said truck body and connected to the shredding unit and located between the driver cab and shredding unit;
a hopper mounted below the shredding unit for collecting shreds;
a storage unit mounted adjacent to the shredding unit and hopper, and toward the rear of the truck body;
a ram unit positioned to compress and push the shredded paper from the hopper into the storage unit.

2. A paper shredding truck unit according to claim 1 in which the shredding, lifting, and ram units are hydraulically driven.

3. A paper shredding truck unit according to claim 1 in which the shredding, lifting, and ram units are electrically driven.

4. A paper shredding truck unit according to claim 1 in which the shredding unit is directly driven by an engine mounted in the truck cab.

5. A paper shredding truck unit according to claim 1 in which the lifting arm is mounted on the curb side of the truck body.

6. A paper shredding truck unit according to claim 1 further comprising a control system for lifting containers; shredding paper and compressing along with moving the shreds to the storage unit.

7. A paper shredding truck unit according to claim 6 in which the control systems are integrated for automated control of all operations.

8. A method for collecting, shredding, compressing, and storing paper comprising:
selecting a truck body including 4 sides designated as front, rear, driver side and curb side;
mounting a truck cab on a front of said truck body;
mounting a shredder unit including a drive mechanism toward the rear of the truck body and adjacent to the cab;
mounting a lifting unit on said truck body wherein the lifting unit is designed to lift containers of paper;
mounting a hopper below the shredder unit;
mounting a ram in the hopper wherein it is designed for adjacent to and toward the rear of the hopper;
mounting a storage unit toward the rear of the truck and adjacent to the hopper;
utilizing the lifting unit to position the containers over the shredding unit and dumping the paper into the shredding unit;
running the shredder to shred al the paper;
utilizing the ram to compress and push the contents of the hopper into the storage unit mounted push the shredded paper into the storage unit; and
discharging the shredded paper from the storage unit.

9. A method for collecting, shredding, compressing, and storing paper according to claim 8 in which the shredding, lifting, and ram units are hydraulically driven.

10. A method for collecting, shredding, compressing, and storing paper according to claim 8 in which the shredding, lifting, and ram units are electrically driven.

11. A method for collecting, shredding, compressing, and storing paper according to claim 8 further comprising a control system for lifting containers; shredding paper and compressing along with moving the shreds to the storage unit.

12. A method for collecting, shredding, compressing, and storing paper according to claim 11 in which the control systems are integrated for automated control of all operations.
